(19) United States
(12) Patent Application Publication
(10) Pub. No.: US 2016/0193742 A1
(43) Pub. Date: Jul. 7, 2016

(54) ERGONOMIC KNIFE ATTACHMENT

(71) Applicant: Norman Faiola, Liverpool, NY (US)

(72) Inventor: Norman Faiola, Liverpool, NY (US)

(21) Appl. No.: 14/591,276

(22) Filed: Jan. 7, 2015

(51) Int. Cl. B26B 29/02; B26B 3/00

(52) U.S. Cl. CPC B26B 29/02; B26B 3/00

(57) ABSTRACT

A device that may be attached to the blade of a knife to improve safety. The device has a central juncture and a pair of opposing legs having free ends that extend from the central juncture to define a gap therebetween. The free ends of the opposing legs are held in frictional engagement with each other. The gap is dimensioned to accept the blade of a knife and the central juncture will extends along a plane at right angles to the blade of the knife to accommodate the first phalanx of a human index finger. A cushioning layer is positioned over the central juncture and pair of opposing legs to improve gripping by a user and thus improve safety.

### BACKGROUND OF THE INVENTION

1. Field of the Invention

The present invention relates to cutlery and, more specifically, to an attachment for a knife that improves grip and encourages safe use.

2. Description of the Related Art

The proper use of kitchen cutlery involves a user grasping the handle and blade of a knife so that the thumb and index finger actually rest on either side of the blade of a knife with the phalanx of the index finger positioned along the spine of the knife blade. This method of gripping a knife is difficult to master and, when not performed properly, can lead to accidents. Thus, there is a need in the art for a device to assist a user with properly grasping a knife.

### BRIEF SUMMARY OF THE INVENTION

A device for attachment to the blade of a knife having a central juncture having a predetermined width and a pair of opposing legs having free ends extending from the central juncture to define a gap therebetween, wherein the free ends of the opposing legs are held in frictional engagement with each other. The gap defined by the pair of opposing legs is dimensioned to accept the blade of a knife. The central juncture extends along a plane and is dimensioned to accommodate the first phalanx of a human index finger. The plane of the central juncture is oriented to be at right angles to a plane of a blade of a knife positioned in the gap. A cushioning layer is positioned over the central juncture and pair of opposing legs to improve gripping by a user and thus improve safety. An adhesive layer may affix the cushioning layer over the central juncture and pair of opposing legs.

The device is used by inserting a knife having a blade into the gap between the pair of opposing legs so that the central juncture rests on a non-cutting edge of the blade. The device is then slid device along the blade of the knife until it abuts a handle of the knife. A user may then safely use the knife by holding the knife so that the first phalanx of the user's index finger (the segment closest to the hand) rests on the top of device, with the user's index fingertip pressing on one clamping leg of the invention while the user's thumb presses on the other clamping leg of the invention. The user's other three fingers wrap around the handle of the knife.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a perspective view of the preferred embodiment of the invention;

FIG. 2 is a perspective view of the invention mounted on a knife;

FIG. 3 is an end view of the invention mounted on a knife;

FIG. 4 is an end view of the invention mounted on a knife and gripped by a user;

FIG. 5 is a side view of the method of affixing and removing the invention to a knife.

### DETAILED DESCRIPTION OF THE INVENTION

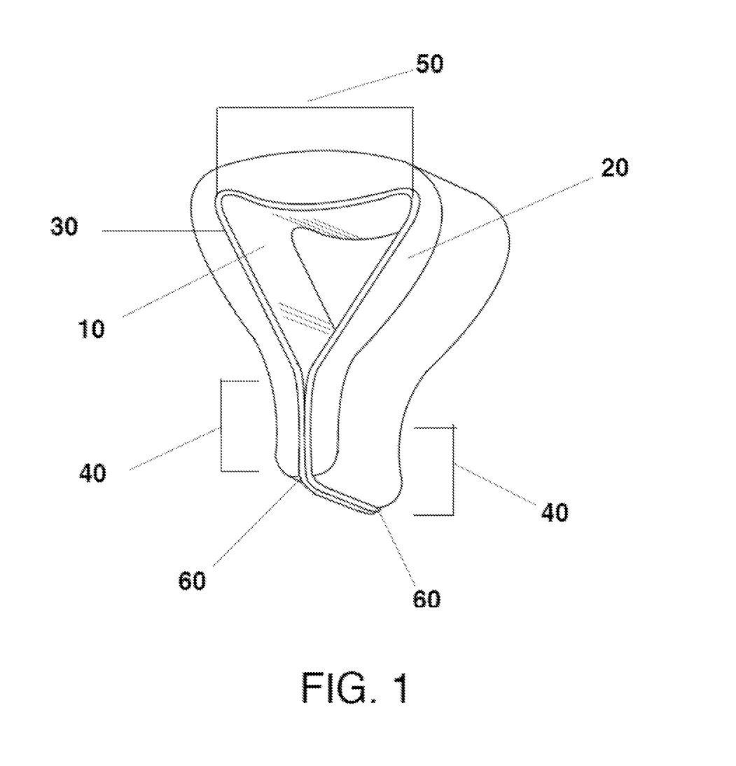

Referring now to the drawings, wherein like reference numerals refer to like parts throughout, there is seen in FIG. 1 a food-safe, spring-tempered, stainless steel clamping device 10 having a non-toxic silicone or other cushioning layer 20 affixed to the exterior of device 10, such as by a suitable silicone adhesive layer 30. Clamping legs 40 flexibly extend from a central juncture 50 and, due to the geometrical design of the juncture 50, allow clamping legs 40 to forcibly contact each other at their distal ends 60. Device 10 may be made from any spring material, such as metals and plastics, which will allow clamping legs 40 to securely grasp and be held in place on the blade of a knife. For example, stainless steel grades 409, 410, 430, 201, 202, or 304, may be used with grade 304 preferred. Cushioning layer 20 preferably comprises a Generally Regarded As Safe (GRAS) silicone basic polymer as described in ASTM method D1418-81, Standard Practice for Rubber and Rubber Latices—Nomenclature, such as silicone (Si) elastomers containing methyl groups and having a preferred durometer of about 20 Shore A, such as XIAMETER® RBL-2004-20 LSR A&B available from Dow Corning.

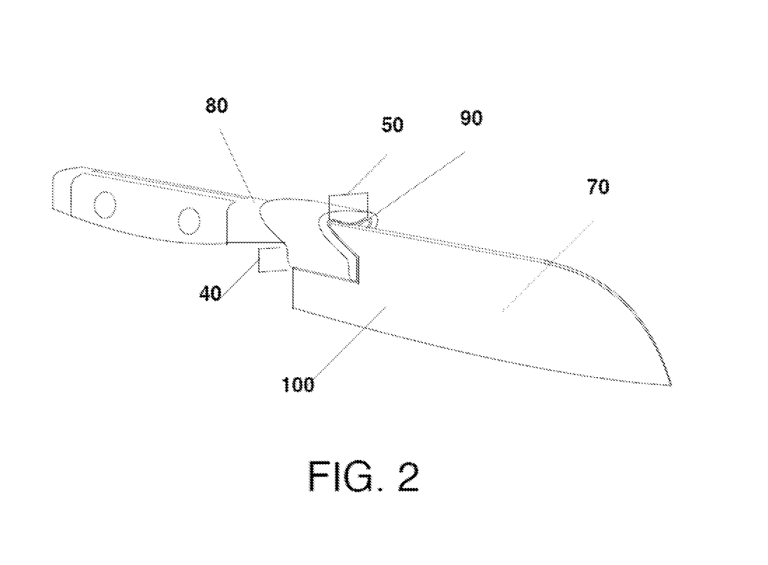

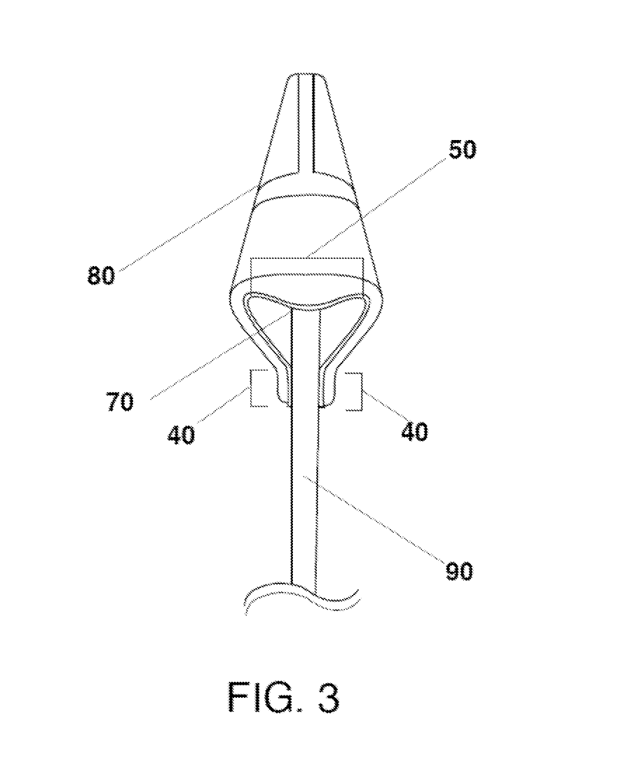

Referring to FIGS. 2 and 3, device 10 is shown mounted on a knife 70 so that device 10 is positioned against the handle 80 with the spine 90 of the knife 70 firmly seated against juncture 50 of device 10 in positioned the gap formed between clamping legs 40, thereby allowing pressure applied by user onto the top of juncture 50 to apply pressure on spine 90 of knife 80. Clamping legs 40 apply sufficient lateral clamping force against the two opposing faces 100 of knife 70 to maintain the position of the device 10 during use. Juncture 50 extends along a plane so that it is generally positioned at right angles to the blade of knife 70 when installed thereon.

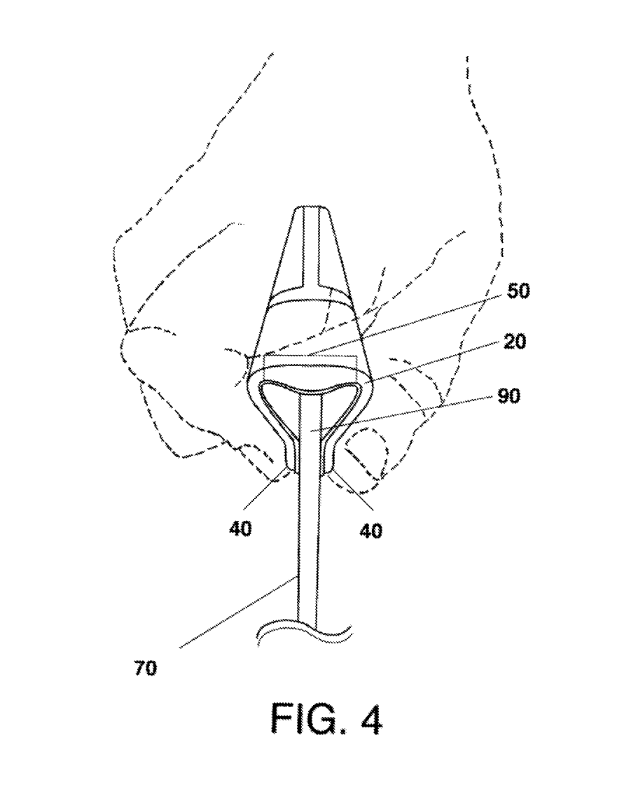

Referring to FIG. 4, device 10 is shown mounted on a knife 70 so that a user's thumb and index finger may be comfortably positioned on opposing clamping legs 40 of the device 10. The broadening geometry of juncture 50 of clamping legs 40 and cushioning material 20 positioned over juncture 50 of clamping legs 40 diffuses the resistance forces acting on the user's index finger from spine 90 of knife 70. Cushioning material 20 extending over each clamping leg 40 also diffuses the forces applied by the user's index fingertip and thumb and further improves the user's control of knife 70, particularly in wet conditions. The resulting grip provided to the user affords superior control and is thus safest and very ergonomic.

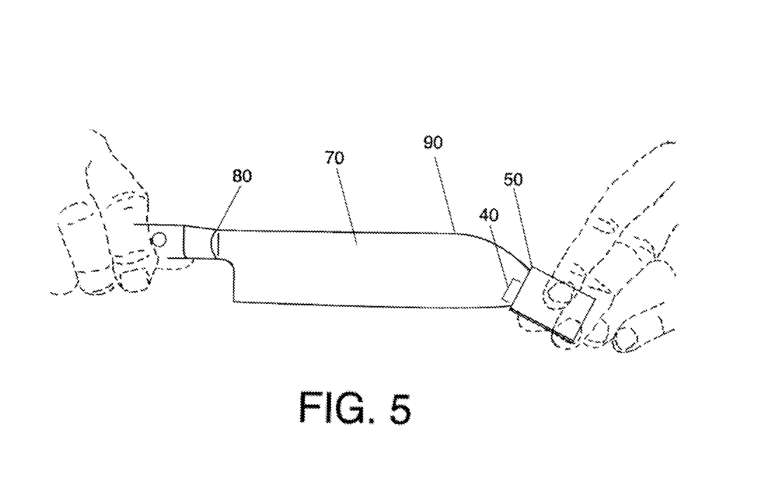

Referring to FIG. 5, to mount device 10 on the spine 90 of the knife 70, a user places the tip of the knife 70 into the space formed by the geometry of juncture 50 of clamping legs 40 and slides device 10 along spine 90 until it abuts handle 80 of knife 70. Removing device 10 is accomplished by reversing these steps. Because strong clamping forces in device 10 are desirable, this approach for affixing and removing device 10 requires much less force, and is therefore safer, than press-fitting device 10 onto spine 90 directly at its final position where device 10 abuts handle 80.

Once affixed to a knife, a user may hold the knife so that the first phalanx of the user's index finger (the segment closest to the hand) rests on the top of device 10, with the user's index fingertip pressing on one clamping leg of the invention while the user's thumb presses on the other clamping leg of the invention. The user's other three fingers wrap around the handle of the knife as is normally the case. If knife 70 outfitted with device 10 is placed on a horizontal surface, such as a cutting board or table top, knife 70 will be less likely to slip due to cushioning layer 20 having better frictional contact with most surfaces than metal blades or handle materials. Knife 70 will also be easier to pick up from a horizontal surface as device 10 will partially lift knife 70 off of the surface, thereby improving safety even when knife 70 is not being used to cut. Device 10 may also be provided in a variety of colors, which can be color coded for certain types or categories of food to promote food safety by preventing cross-contamination such organisms such as bacteria or cross-contact of allergens.

The present invention thus comprises an ergonomic attachment that removably affixes to the spine of kitchen knives and similar cutting implements to improve the user's comfort, proper grip and safety. By eliminating the discomfort associated with the proper knife-holding grip, wherein the index finger of the user's grip hand forcefully presses on the narrow spine of the blade, the invention improves knife ergonomics and allows continuous work without injury or compromising grip adjustments. By further providing an enhanced gripping surface for a user's thumb and index finger, the invention reduces the exertion needed to hold the knife securely without slippage, increasing safety and further enabling continuous work. The cushioning surface of the invention also improves ergonomics of the gripping forces applied by a user's finger and thumb. The removability of the invention permits periodic cleaning and sterilization.

It is further understood that there are embodiments of this invention that will be obvious to one skilled in the art in view of the foregoing specification, and it is intended that these embodiments be included within the scope of this invention, which scope is limited only by the scope of the appended claims.

What is claimed is:

1. A device for attachment to the blade of a knife, comprising:
a central juncture having a predetermined width;
a pair of opposing legs having free ends extending from the central juncture to define a gap therebetween, wherein the free ends of the opposing legs are held in frictional engagement with each other.

2. The device of claim 1, wherein the gap defined by the pair of opposing legs is dimensioned to accept the blade of a knife.

3. The device of claim 2, wherein the central juncture extends along a plane.

4. The device of claim 3, wherein the width of central juncture is dimensioned to accommodate the first phalanx of a human index finger.

5. The device of claim 3, wherein the plane of the central juncture is oriented to be at right angles to a plane of a blade of a knife positioned in the gap defined by the pair of opposing legs.

6. The device of claim 4, further comprising a cushioning layer positioned over the central juncture and pair of opposing legs.

7. The device of claim 6, further comprising an adhesive layer affixing the cushioning layer over the central juncture and pair of opposing legs.

8. A method of improving the use of a knife, comprising the steps of:
providing a device having a central juncture with a predetermined width and a pair of opposing legs having free ends extending from the central juncture to define a gap therebetween, wherein the free ends of the opposing legs are held in frictional engagement with each other;
inserting a knife having a blade into the gap between the pair of opposing legs so that the central juncture rests on a spine of the blade;
sliding the device along the blade of the knife until it abuts a handle of the knife.

9. The method of claim 8, wherein the gap defined by the pair of opposing legs is dimensioned to accept the blade of a knife.

10. The method of claim 9, wherein the central juncture extends along a plane.

11. The method of claim 10, wherein the width of central juncture is dimensioned to accommodate the first phalanx of a human index finger.

12. The method of claim 11, wherein the plane of the central juncture is oriented to be at right angles to a plane of a blade of a knife positioned in the gap defined by the pair of opposing legs.

13. The method of claim 12, further comprising a cushioning layer positioned over the central juncture and pair of opposing legs.

14. The method of claim 13, further comprising an adhesive layer affixing the cushioning layer over the central juncture and pair of opposing legs.
